(19) United States
(12) Patent Application Publication
(10) Pub. No.: US 2014/0352267 A1
(43) Pub. Date: Dec. 4, 2014

(54) DEVICE FOR SECURING A HORSE-RIDING SADDLE ONTO A HORSE

(71) Applicant: Patrick Fourgeaud, Bayonne (FR)

(72) Inventor: Patrick Fourgeaud, Bayonne (FR)

(73) Assignee: BRD CONCEPT, Anglet (FR)

(21) Appl. No.: 14/365,756

(22) PCT Filed: Dec. 7, 2012
(86) PCT No.: PCT/FR2012/052839

§ 371 Date: Jun. 16, 2014

(30) Foreign Application Priority Data
Dec. 15, 2011 (FR) 1161656

(51) Int. Cl. B68C 1/14

(52) U.S. Cl. CPC B68C 1/14
USPC 54/23

(57) ABSTRACT

A device for securing a horse-riding saddle onto a horse, includes a strap (32) having at least one first textile part (34) with an elongation of 10% to 20%, the strap encircling the topline (20), flanks (24) and underline (26) of the torso of the horse, extending over the entire periphery of the torso of the horse, and an element for linking the saddle, which is connected to the first textile part (34).

This invention relates to a device for securing on a horse a seat for a horseback rider.

In the field of equitation, to be mounted, a horse must be equipped with a saddle forming a seat for a horseback rider.

This saddle generally comprises a rigid saddletree that is adorned with padding and leather flaps. This saddle, placed on the horse on the line of its back, is secured to the horse using a strap that extends from one side to the other of the saddletree by encircling the horse at the level of its rib cage.

To ensure the stability of the saddle and to keep it from sliding to one side, it is necessary that this strap exerts a significant compressive force on the rib cage of the horse and that it is essentially inelastic.

According to a first negative point, the force exerted on the horse by the strap is localized and distributed over a small surface area corresponding to its width on the order of 5 to 10 cm, which is reflected by very significant contact pressures that can be painful for the horse.

According to a second negative point, the strap forms with the saddletree an inelastic belt that hampers the horse's breathing and optionally its movements.

According to another negative point, like the strap, the saddletree exerts compressive forces on both sides of the topline that hamper the movements of the horse.

In the field of equitation, a piece of equipment for teaching equitation whose purpose is to eliminate the saddle is also known according to the document FR-2,121,933. On the one hand, the latter comprises a cover covering the horse's body with an outside surface coated with an adhesive material, and, on the other hand, the latter comprises sheepskins that are attached to the inner surfaces of the horseback rider's pant legs and that adhere to the cover. Like the saddle, the cover is secured on the horse using a strap that extends from one side to the other of the cover for encircling the horse at its rib cage.

This approach has as its primary advantage to eliminate the saddletree of the saddle, which tends to reduce the compressive forces on both sides of the topline of the horse.

However, as above, the force exerted on the horse by the strap is localized and distributed over a still smaller surface area corresponding to its width on the order of 5 to 10 cm, which is reflected by very significant contact pressures that may be painful for the horse.

In addition, the cover and the strap form an inelastic belt that hampers the breathing of the horse and optionally its movements.

Also, according to the document EP-441,781, a device is known that makes it possible to keep a cover on the back of the horse. This device comprises two superposed layers that can slide relative to one another and that cover the shoulders and the neck of the horse. Taking into account its location, this device is not suitable for securing a seat such as a saddle on the horse. Even if this device extended toward the rear of the horse's body, it would not be suitable for holding a saddle, taking into account the sliding between the two layers and the nature of the layers.

Also, the purpose of this invention is to resolve the problems of the prior art by proposing a device for securing on a horse a seat for a horseback rider that does not hamper the movements of the horse and that does not cause pain for the animal while ensuring an effective holding of the saddle.

For this purpose, the invention has as its object a device for securing on a horse a seat for a horseback rider, characterized in that it comprises a strap with at least a first piece of cloth with an elongation of between 10 and 20% that encircles the horse at the level of its topline, flanks, and its underline of the body and extends over the entire outline of the horse's body, and connecting means of the seat connected to the first piece of cloth.

Other characteristics and advantages will emerge from the following description of the invention, a description provided only by way of example, relative to the accompanying drawings, in which:

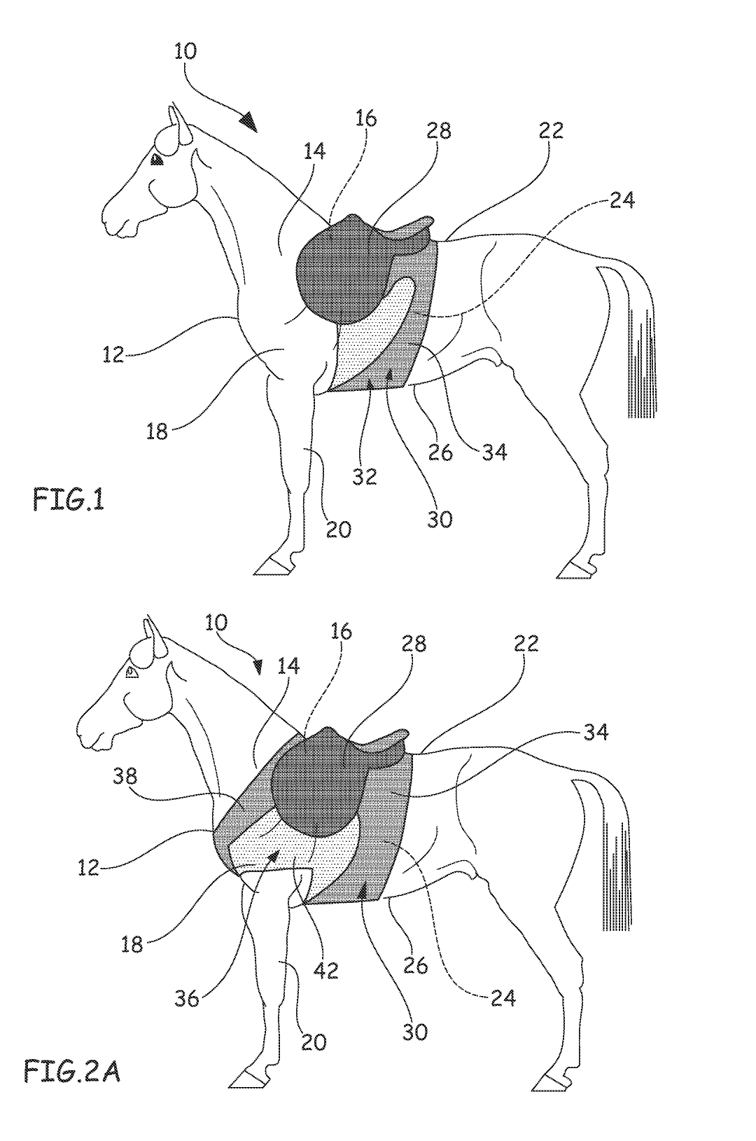

FIG. 1 is a lateral view of a horse equipped with a device according to a first variant of the invention,

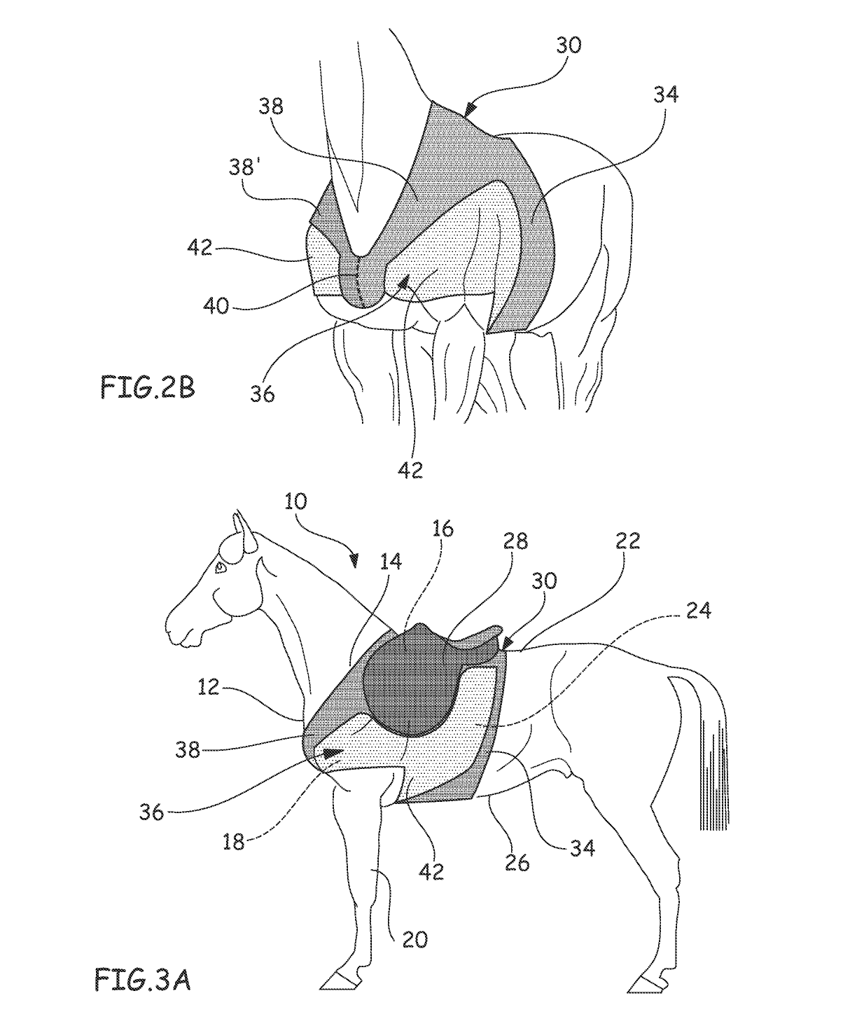

FIG. 2A is a lateral view of a horse equipped with a device according to a second variant of the invention,

FIG. 2B is a view of the front of the horse of FIG. 2A,

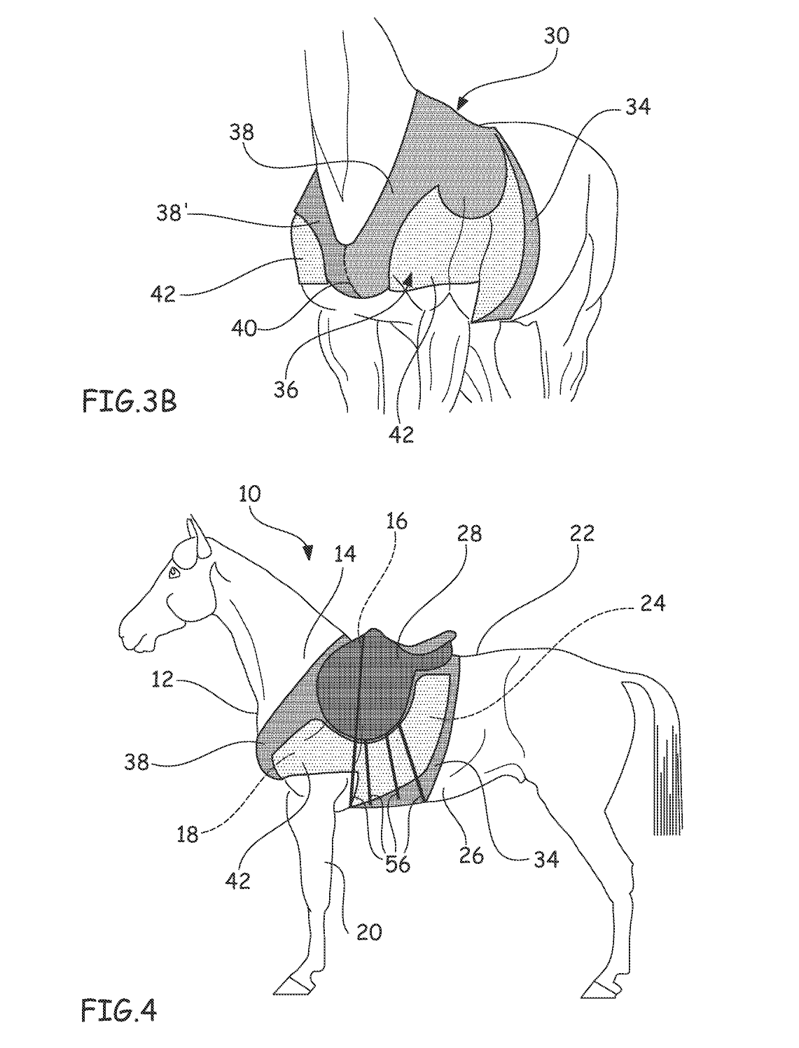

FIG. 3A is a lateral view of a horse equipped with a device according to a third variant of the invention,

FIG. 3B is a view of the front of the horse of FIG. 3A,

FIG. 4 is a lateral view of a horse equipped with a device according to a fourth variant of the invention,

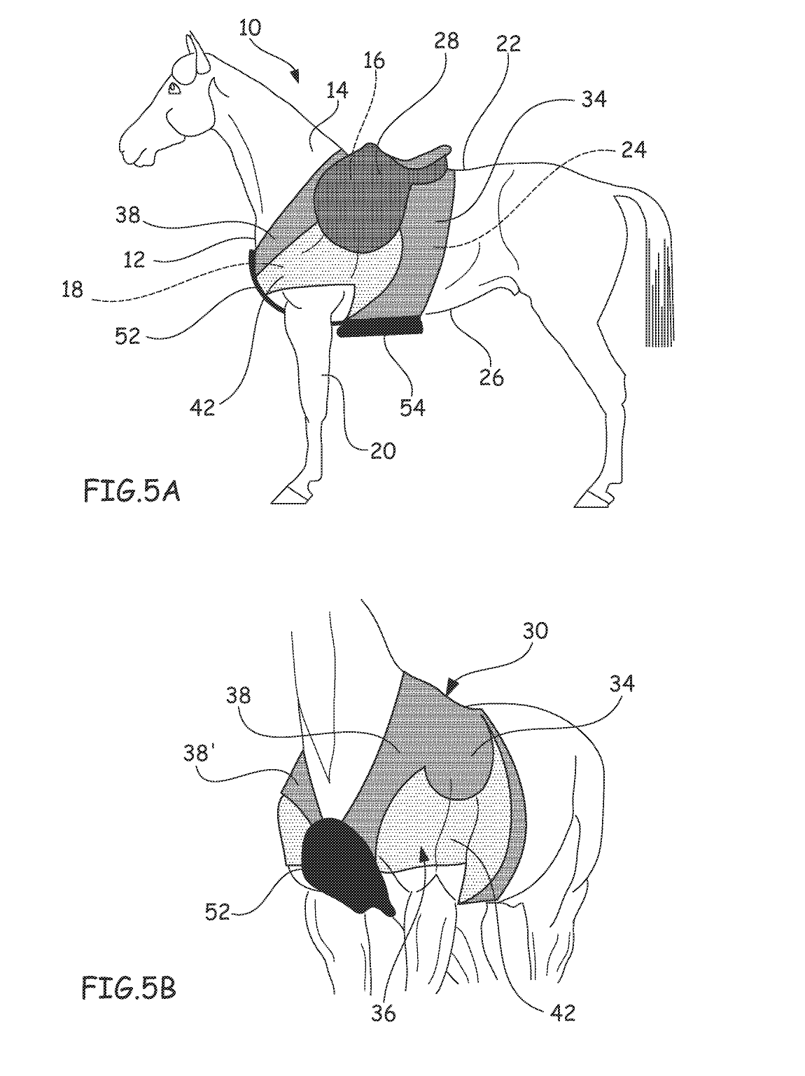

FIG. 5A is a lateral view of a horse equipped with a device according to a fifth variant of the invention,

FIG. 5B is a view of the front of the horse of FIG. 5A,

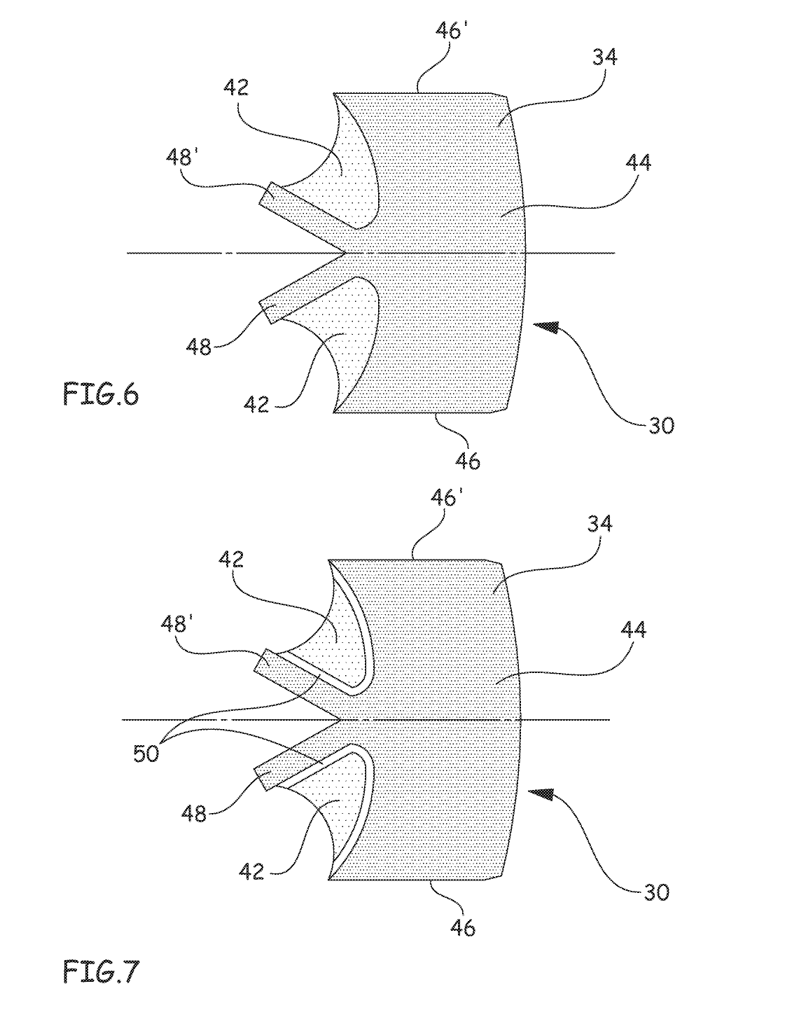

FIG. 6 is a flat view of a device according to a first variant of the invention, and

FIG. 7 is a flat view of a device according to another variant of the invention.

In the various figures, a horse 10 is shown with a chest at 12, a neck at 14, withers at 16, a shoulder at 18, a foreleg at 20, a topline at 22, a flank at 24, and an underline of the body at 26.

Hereinafter, the longitudinal direction corresponds to a direction that is parallel to the topline 22. A transverse plane is a plane that is perpendicular to the longitudinal direction.

At 28, a saddle is shown that is connected at the topline 22 to the rear of the withers 16.

Hereinafter, a device for securing on the horse 10 the saddle 28 and more generally a seat for a horseback rider is shown at 30.

According to a simplified embodiment illustrated in FIG. 1, this device comprises a strap 32 that encircles and hugs the horse's body at the topline 22, flanks 24, and the underline of the body 26. In a transverse plane, the strap 32 extends over the entire outline of the horse's body. According to a significant point of the invention, the strap 32 comprises at least one first piece of cloth 34 with an elongation of between 10 and 20% that encircles the horse at the topline 22, flanks 24, and the underline of the body 26 and extends over the entire outline of the horse's body.

For the description, piece is defined as a piece of cloth or several pieces of cloth of the same nature on the elongation plane. Thus, the piece of cloth 34 can be formed by several yokes, each having an elongation of between 10 and 20% and connected to one another by any suitable means such as, for example, by a seam.

When the strap 32 is not placed on the horse, it has a peripheral length L, whereas when it is placed on the horse, it has a length L′ of between Lx1.1 or Lx1.2 in such a way as to obtain an adequate tightening making it possible to limit the sliding of the saddle.

According to another characteristic of the invention, the piece of cloth 34 has a width in the longitudinal direction at the topline 22 and the underline of the body 26 that is greater than 15 cm, or considerably greater than the width of a strap. Taking into account this width and the fact that the piece of cloth 34 extends over the entire outline of the body, the contact pressure exerted by the piece of cloth 34 on the horse is considerably lower than that produced by a strap. Thus, the compressive forces are distributed over the entire surface of the piece 34, which makes it possible to limit the discomfort brought about on the horse.

Preferably, the surface of the first piece of cloth 34 in contact with the horse comprises a coating promoting its adhesion, such as, for example, made of silicone. Because the piece of cloth 34 “adheres” to the horse, it is possible to reduce the compressive forces that are necessary for securing the device on the horse.

To be able to put the device 30 on the horse, this device comprises a longitudinal cut-out that extends at the underline of the body 26. The two adjacent edges placed on both sides of the longitudinal cut-out are connected by a detachable connection, such as, for example, two gripping bands, a closure with a slide, or an analogous system.

According to other variants illustrated in FIGS. 2A, 2B, 3A and 3B, the device 30 comes in the form of a vest 36, namely a strap extended toward the neck that covers the same zones as the variant illustrated in FIG. 1 and in addition the withers 16 and the neck 14. This vest 36 comprises at least one piece of cloth 34 comprising, in addition to the shape of a strap placed around the body, two lateral bands 38, 38′ that are joined at the chest 12. At the front, the two lateral bands 38 and 38′ form a V in such a way as to be free of the throat. This approach makes it possible to limit the sliding of the device in the longitudinal direction.

To be able to put the device on the horse, the device comprises, on the one hand, a longitudinal cut-out that extends at the underline of the body 26, with the two adjacent edges placed on both sides of the longitudinal cut-out being connected by a detachable connection, and, on the other hand, a detachable connection 40, preferably identical to the one that is present at the underline of the body 26, for connecting the two lateral bands 38, 38′ at the chest.

According to another characteristic of the invention, the device 30 comprises two types of pieces of cloth, namely a first piece of cloth 34 and two second pieces of cloth 42 that each cover a shoulder 18.

Thus, according to a preferred embodiment, the first piece of cloth has an elongation of between 10 and 20%, whereas the second pieces of cloth 36 have an elongation of between 40 and 65%.

By way of example, the first piece of cloth 34 is made of polychloroprene-based rubber, in particular made of a material marketed under the trademark Neoprene (preferably mesh), and the second pieces of cloth 42 are produced from Spandex fibers, in particular made of a material that is marketed under the trademark Lycra.

Advantageously, the surface of the first piece of cloth 34 in contact with the horse comprises a coating promoting its adhesion, such as, for example, made of silicone. Because the piece of cloth 34 “adheres” to the horse, it is possible to reduce the compressive forces that are necessary for securing the device on the horse.

According to this preferred embodiment, the device covers the topline, the flanks, and the underline of the body, the shoulders, the neck, and the chest and is derived from the juxtaposition of the first piece 34 and the two second pieces 42 that cover the shoulders. As illustrated in FIGS. 2A and 3A, the surface that is covered by the two second pieces 42 can be more or less large. Thus, they can only cover the shoulder 18, as illustrated in FIG. 2A, or extend from the shoulder 18 toward the rear of the horse and leave only a fine band for the piece 34 at the flanks, as illustrated in FIG. 3A. Taking into account its elongation, the second pieces 42 do not hamper the movements of the horse.

In FIG. 6, the device 30 was shown according to the embodiment with two types of pieces of cloth 34 and 42. It comprises a central part 44 that extends from a lateral edge 46 to another lateral edge 46′ and that has an overall rectangular shape as well as two branches 48, 48′ in the shape of a V that constitute the lateral bands 38, 38′. The lateral edges 46, 46′ as well as the ends of the branches 48, 48′ comprise the parts of a detachable connection. When the device 30 is placed on the horse, the edges 46, 46′ are placed at the underline of the body 26 and are connected by a detachable connection. In parallel, the ends of the branches 48, 48′ are placed at the chest 12 and are connected by a detachable connection 40.

According to another embodiment illustrated in FIG. 7, the device comprises three types of pieces of cloth. Thus, third pieces of cloth 50 in the form of bands ensure the connection between the first piece of cloth 34 and the second pieces of cloth 42.

According to this variant, the first piece of cloth has an elongation of between 10 and 20%, the second pieces of cloth 42 have an elongation of between 40 and 65%, and the third pieces of cloth 50 have an elongation of 20 to 40%. This approach makes it possible to limit the puckering at the junction zones between the pieces 34 and 42.

Advantageously, as illustrated in FIGS. 5A and 5B, the device 30 comprises a band of longitudinal material 52 that covers the zone of the horse that extends from the chest 12 up to the underline of the body 26 by passing between the forelegs 20. For this purpose, the band of longitudinal material 52 rejoins the junction zone of the two lateral bands 38, 38′ of the collar at the zone located at the underline of the body 26.

According to an embodiment, this longitudinal band 52 can be a piece of cloth, which may or may not be independent of the pieces of cloth 34 and 42.

Advantageously, this longitudinal band 52 can comprise—at at least one part of its outer surface—a system 54 that is damping and optionally anti-abrasive for protecting the horse from possible impacts with its hooves during the practice of certain disciplines such as jumping obstacles.

By way of example, this damping system 54 comprises several layers, namely a rigid shell toward the outside, an intermediate layer made of a material damping the impacts, and a cloth layer in contact with the horse's body and/or the pieces 34 and 42. As damping material, it will be possible to use a foam material and/or a gel and/or a three-dimensional cloth.

For making the saddle integral, the device 30 comprises connecting means that are integral with the first piece of cloth 34.

According to a first variant, the connecting means come in the form of a gripping interface (Velcro® type) or an adhesive interface.

According to another variant, the connecting means can comprise housings (in the form of pockets) at the device 30 in which parts of the saddle can be inserted for limiting the movements of the saddle relative to the device.

According to another variant, the connecting means can comprise loops, or girth straps 56. In contrast to a traditional strap, these girth straps 56 do not encircle the horse's body.

Advantageously, as illustrated in FIG. 4, these girth straps are made integral at several places on the first piece of cloth 34 so as to distribute the tightening forces.

1. Device for securing on a horse a seat for a horseback rider, characterized in that it comprises a strap (32) with at least a first piece of cloth (34) with an elongation of between 10 and 20% that encircles the horse at its topline (22), flanks (24), and its underline of the body (26) and extends over the entire outline of the horse's body, and connecting means of the seat connected to the first piece of cloth (34).

2. Device according to claim 1, wherein the first piece of cloth (34) has a width in the longitudinal direction at the topline (22) and the underline of the body (26) of greater than 15 cm.

3. Device according to claim 1, wherein the surface of the first piece of cloth (34) in contact with the horse comprises a coating promoting its adhesion.

4. Device according to claim 1, wherein it comprises a longitudinal cut-out that extends at the underline of the body (26) and that delimits two edges placed on both sides of the longitudinal cut-out connected by a detachable connection.

5. Device according to claim 1, wherein it comprises two lateral bands (38, 38′) that are joined at the chest (12).

6. Device according to claim 5, wherein it comprises a detachable connection (40) for connecting the two lateral bands (38, 38′) at the chest.

7. Device according to claim 5, wherein it comprises a first piece of cloth (34) with an elongation of between 10 and 20% and two second pieces of cloth (42) that each cover a shoulder (18) with an elongation of between 40 and 65%.

8. Device according to claim 7, wherein it comprises third pieces of cloth (50) in the form of bands that ensure the connection between the first piece of cloth (34) and the second pieces of cloth (42) with an elongation of 20 to 40%.

9. Device according to claim 5, wherein it comprises a longitudinal band (52) that rejoins the junction zone of the two lateral bands (38, 38′) of the collar at the zone located at the underline of the body (26).

10. Device according to claim 9, wherein the longitudinal band (52) comprises a damping system (54) at at least one part of its outside surface.

11. Device according to claim 1, wherein the connecting means comprise loops or girth straps (56) made integral at several places on the first piece of cloth (34).

12. Device according to claim 2, wherein the surface of the first piece of cloth (34) in contact with the horse comprises a coating promoting its adhesion.

13. Device according to claim 6, wherein it comprises a first piece of cloth (34) with an elongation of between 10 and 20% and two second pieces of cloth (42) that each cover a shoulder (18) with an elongation of between 40 and 65%.

14. Device according to claim 6, wherein it comprises a longitudinal band (52) that rejoins the junction zone of the two lateral bands (38, 38′) of the collar at the zone located at the underline of the body (26).
